(19) United States
(12) Patent Application Publication
(10) Pub. No.: US 2026/0010333 A1
(43) Pub. Date: Jan. 8, 2026

(54) HEARABLE DEVICE TO HEARABLE DEVICE COMMUNICATION USING IMAGE RECOGNITION

(71) Applicant: Sony Group Corporation, Tokyo (JP)

(72) Inventors: James R. Milne, Ramona, CA (US); Brant L. Canderlore, Poway, CA (US); Justin Kenefick, San Diego, CA (US); William Clay, San Diego, CA (US)

(73) Assignee: Sony Group Corporation, Tokyo (JP)

(21) Appl. No.: 18/766,513

(22) Filed: Jul. 8, 2024

(51) Int. Cl. G06F 3/16; G06F 3/01; G06V 40/16; G06V 40/18; G10L 25/51; H04R 1/10

(52) U.S. Cl. CPC G06F 3/165; G06F 3/013; G10L 25/51; H04R 1/1091; G06V 40/168; G06V 40/18; H04R 2420/07

(57) ABSTRACT

A hearable communication system is provided to enable a user to converse with target persons physically located in the environment of the user by connecting hearable devices. A target person is identified by analyzing images taken of persons in the environment and matching visual indicators from the images to stored identifying information for target persons of interest to the user. Additional identifying information, such as broadcast identifiers for hearable devices and group membership information may also be employed in the identification process. Once the target person is confirmed, a hearable device of the user is connected with a hearable devices of the target person. Detection of a stopping action can then trigger disconnection of the hearable devices to end the audio conversation.

### CROSS REFERENCES TO RELATED APPLICATIONS

This application is related to the following application, U.S. patent application Ser. No. 18/136,620, entitled AUDITORY DEVICE TO AUDITORY DEVICE COMMUNICATION LINKING, filed on Apr. 19, 2023 (020699-122700US/SYP350748US01), which is hereby incorporated by reference as if set forth in full in this application for all purposes.

### BACKGROUND

During conversations people can sometimes struggle to hear others, especially in an environment that is not conducive to hearing people talk. Disruptive environments can include loud noise interferences, persons conversing being too far apart, interfering persons or objects positioned between the persons conversing, etc. It can also be difficult to hear soft voices, for example to keep a conversation discrete. Certain device can connect with other devices for conversations.

Hearable devices (also called “hearables” or “auditory devices”) include a variety of ear worn devices to alter the hearing of the user, such as playing audio close to or into the ear (e.g., headphones, earbuds), blocking from hearing environmental audio (e.g., noise canceling), assisting with hearing of environmental audio (e.g., hearing aids), etc. Hearable devices can also be employed to facilitate hearing and communicating during a conversation.

### SUMMARY

A hearable communication system (also called “communication system” or “system”) is provided that enables a user to converse with one or more target persons physically located in the environment of the user. A hearable device of the user is connected with other hearable devices of the target person(s), based on visual information captured by an image capture device of the user.

A hearable communication method is provided that is implemented by one or more computers in which hearable devices connect for an audio conversation to take place. At least one image is received from an image capture device of a user. A target person in an environment of the user is identified by, at least in part, analyzing the at least one image. In response, at least in part, to identifying the target person, a communication is transmitted to the target person to connect a target hearable device of the first target person with a user hearable device of the user. A communication connection is established between the user hearable device and the hearable device of the target person. The communication connection may be disconnected upon detecting a stopping of the audio conversation through the hearable devices.

In some aspects of the method, prior to establishing the communication connection, a request is outputted to the user to confirm the communication connection with the target person. When a confirmation of the communication connection is received from the user, the communication connection is established. If the confirmation is not received from the user, the communication connection with the target person fails.

In some implementations, analysis of the images may involve various techniques. For example, one or more visual indicators may be extracted from the at least one image and matched with stored distinguishing visual characteristics of the target person. Image recognition (visual recognition) techniques may include facial recognition, iris recognition, gait recognition, and/or combinations thereof. One or more artificial intelligence (AI) models may be applied for the purposes of predicting whether a potential target person in the at least one image is the target person. The AI model may be trained on stored visual indicator data of known target persons.

In some cases, identifying the first target person further includes receiving at least one eye image of the user captured by the one or more inward facing capture sensors. Eye gaze of the user may be tracked from the at least one eye image captured. It may be determined that the eye gaze is in the direction of the first target person.

In still some implementations, additional identifying information may be employed to identify the target person further. For example, a broadcast identifier associated with the target hearable device may be received and matched with a stored broadcast identifier. At times, a received broadcast identifier associated with a particular target person may be different than a stored broadcast identifier in a broadcast identifier library. In these cases, the received broadcast identifier may be added to the broadcast identifier library as being associated with the particular target person.

Another aspect of the connecting hearable devices, in some implementations, may include determining that an identified target person is a member of a group that includes another target person. In these cases, a request to the other target person may be transmitted to connect a hearable device of the other target person with the user hearable device of the user. There upon, second communication connection may be established between the user hearable device and the second hearable device of the other target person. Such connections based on group membership may be made even where visual content in the at least one image is insufficient to identify the other target person in the environment of the user.

The process can include disconnecting the connection of the hearable devices whereby a stopping action that indicates a stopping point of the audio conversation is detected. The user may be requested to provide a confirmation of the stopping point. In response to receiving the confirmation of the stopping point from the user, the first communication connection with the first hearable device may be disconnected.

In some implementations, a hearable communication system is provided, which includes an image capture device and a user hearable device. The image capture device is used to capture at least one image of the environment of a user and has an interface to transmit the image(s) to the user hearable device. The hearable device includes one or more processors and logic encoded in one or more non-transitory media for execution by the one or more processors. When the logic is executed, the logic is operable to perform various operations as described above in terms of the method. The operations include at least some of the methods described above.

In some implementations, a non-transitory computer-readable storage medium is provided which carries program instructions for connecting hearable devices for an audio conversation. These instructions when executed by one or more processors cause the one or more processors to perform operations as described above for the hearable communication method described above.

A further understanding of the nature and the advantages of particular embodiments disclosed herein may be realized by reference of the remaining portions of the specification and the attached drawings.

### BRIEF DESCRIPTION OF THE DRAWINGS

The disclosure is illustrated by way of example, and not by way of limitation in the figures in which like reference numerals are used to refer to similar elements.

FIG. 1 is a conceptual diagram illustrating a plan view of an example setting in which various aspects of the hearable communication system can be implemented, in accordance with some implementations.

FIG. 2 is a block diagram of an example of components of an environment that includes the hearable communication system, in accordance with some implementations.

FIG. 3 is a block diagram of components of the hearable communication system usable to implement in the processes of FIGS. 8-10, in accordance with some implementations.

FIG. 4 is an example data table for storing identifying information for use with the hearable communication system, in accordance with some implementations.

FIG. 5 is a conceptual diagram illustrating an example of the hearable communication system that includes eye movement detection to identify a target person in a field of view, in accordance with some implementations.

FIG. 6 is a conceptual diagram illustrating an example of the hearable communication system that includes group communication, in accordance with some implementations.

FIG. 7 is a conceptual diagram illustrating an example of the hearable communication system that includes an outward facing image capture device coupled to a hearable device, in accordance with some implementations.

FIG. 8 is a flow diagram of an example method for hearable devices to connect for an audio conversation, in accordance with some implementations.

FIG. 9 is a flow diagram of an example multi-modal communication method to use combinations of various identifying information to detect a target person, in accordance with some implementations.

FIG. 10 is a flow diagram of an example stopping method to disconnect a connection of hearable devices for an audio conversation, in accordance with some implementations.

### DETAILED DESCRIPTION OF EMBODIMENTS

The present hearable communication system enables hearable devices to connect for a user to have a conversation with target person(s) directly from one hearable device to another hearable device. Target persons in an environment of the user are identified by analyzing images taken by an image capture device of the user. Visual indicators may be extracted from visual content in the images to determine the target persons the user may desire to participate in the conversation. Other identifying information may also be considered in determining the target persons.

A “user” of the hearable communication system as applied in this description, refers to at least one person with a hearable device and image capture device of the hearable communication system, who is party to a conversation with other target person(s) who also have respective hearable devices. The hearable device of the user is directed to connect with one or more hearable devices of target person(s) via visual image recognition of at least one or the target person(s), A target person(s) is one or more persons other than the user recognized by the hearable communication system as a participant for a conversation, with whom the user may listen to and/or talk. In some implementations, a target person may be identified by the system and the user may opt to decline the conversation with the target person.

A “conversation” as referred to herein is speech transmitted through a hearable device to another hearable device. The conversation may be two-sided to include speech by a target person directed to the user and the user may contribute by speaking to the target person. The conversation may also be one-sided to include speech by one party to the conversation, such as the target person and the user does not speak to the target person. At times, the conversation may include multiple target persons in a group conversation where individual target persons speak sequentially for example by taking turns, or speaking at the same time, for example reciting speech in unison or interrupting each other. The speech may include talk, singing, and other vocalizations by the target person/user intended to convey information. In some implementations, at points in the conversation any of the user and or target person may act as a receiving person by listening to the speech of the speaking person.

The present hearable communication system addresses potential issues that can arise when using other types of device connection systems. For example, other indirect communication systems may rely on a user device transmitting speech to a server, which then relays the speech to a target person device, and vice versa. With indirect communication systems, a delay in transmitting speech to the receiving person may occur and result in the conversation not matching with visual cues of the person speaking seen by the receiving person. In still other communication systems, a hearable may connect, e.g., via Bluetooth, with a smart phone for the hearable to assist with phone calls through the smartphone. Such networks require cellular or WiFi connections to the other party to the conversation.

The present hearable communication system circumvents such problems by directly connecting hearable device to hearable device using a variety of networks, such as short range communication protocols, e.g., Bluetooth, Bluetooth LE Audio, wide band, ultra-wide band, etc., which can minimize lag time. The conversation is communicated directly via hearable devices of persons who are party to the conversation, without needing to transmit the communication to intermediary devices. In this manner, one or more hearable devices are directly linked for purposes of transmitting and receiving conversation sounds. The present system has additional benefits that will be apparent by this description.

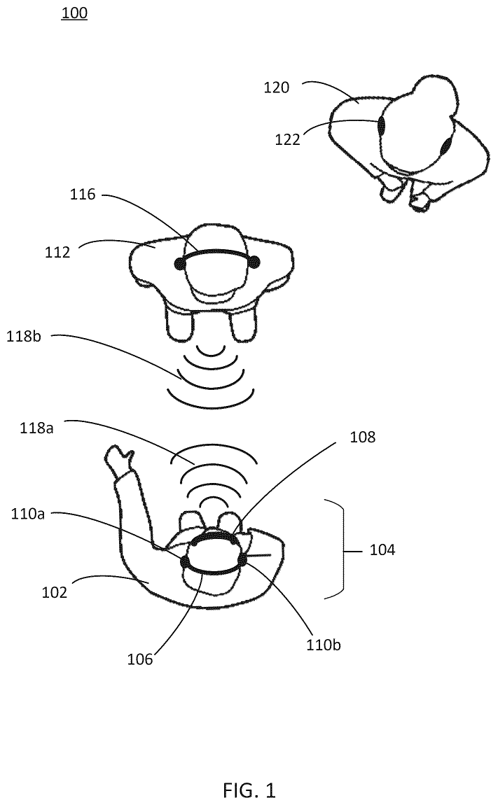

FIG. 1 is a pan view of an example use case illustrative of the hearable communication system 104 employed by a user 102 in an environment 100 to enable the user 102 to have a conversation with a target person 112. An image capture device 108 of the communication system 104 is worn by the user 102 to couple with a user hearable device 106 of the communication system 104, also worn by the user 102. The user hearable device 106 communicates with a target hearable device 116 worn by the target person 112.

The type of user hearable device 106 depicted in FIG. 1 shows a headphone type hearable with a left hearing unit 110a and right hearing unit 110b that cup over the respective ears of the user 102 and are couple to each other via a band 106. Other hearable may be earbuds worn at one or both ears of a user, one or a pair of hearing aids, etc. The hearable device may be inserted into the ear, implanted into the ear, worn over part of the head, such as a hat or band, etc. The hearable may also be a component of a wearable system including other devices, such as smart glasses, smart watch, etc.

The user hearable device 106 includes one or more microphones (not shown), such as in one or both of the hearing unit and/or a microphone component attached to the user hearable device 106. The user 102 may speak and the sounds are detected by the microphone of the hearable device, a voice pick-up sensor or other voice detection technology. When the user hearable device 106 is in a communication mode, conversation sounds made by the user are detected by the microphone and the sound signals are converted into electronic signals transmitted directly to the target hearable device 116 of the target person 112, such as via Bluetooth audio signals 118am e.g., radio waves. Typically, the target hearable device 116 also includes a microphone to capture voice of the target person and transmit the conversation sounds in the form of audio signals 118b to the user hearable device 106 for the user 102 to hear the sounds. As a result, a noisy environment interferes less with the ability to hear and participate in the conversation while using the hearable communication system than for a conversation taking place in open space.

The image capture device 108, for example smart glasses worn by the user, takes images, such as videos, still photographs, or other images that include identifying visual features of persons in the environment 100 of the user 102. The images may capture faces, bodies, movement, portions of faces or bodies, such as iris, ears, and the like, which create identifying data that are analyzed for identification of one or more target persons in the environment. Note that in some implementations, identification of the target person by the communication system 104 may be provided with or without the user 102 needing to recognize or even see the target person 112 in the environment 100, as long as the image capture device 108 picks up on identifying features of the target person 112 sufficient to identify the target person to within a confidence threshold.

In the example of FIG. 1, the image capture device captures images of the target person 112, as well as background person 120. The target person 112 is identified by the communication system 104 as a person with whom the user 102 may desire to converse. Analysis of visual content of the images may result in detection of one or more visual indicators that match with stored characteristics of the target person 112. For example, stored identifying information corresponding to the target person may indicate that the target person is someone that the user 102 had previously conversed with, as a significant person to the user 102, as a member of a significant group to the user 102, or otherwise correspond to a person of interest to the user 102.

In response to identifying the target person, the system may output a request to the user 102 to confirm conversation connection with target person 112. In some implementations, a communication for the conversation connection may be automatically sent to the target person 112 without requiring confirmation from the user 102. In some implementations, the conversation connection may be established in response to a pairing request initiated by a device of the target person 112 to the user 102. In such cases, upon recognition of the target person through analysis of the images, an acceptance of the pairing request may be transmitted to the device of the target person 112.

The conversation connection may take place during an interaction period between the user and one or more target person(s). The interaction period may be initiated when the hearable devices are connected and ended at a stopping point. The initiation of the interaction period may also occur upon various initiation triggers. For example, initiation may be at the commencement of the conversation, manually controlled by the user, such as via user input when the user is about to enter into a conversation with the target person, or detecting conversational speech by the target person.

The stopping point of the interaction period may occur when a stopping action is detected, such as when the conversation is determined to have ceased and the communication system detects that no speech has occurred by the target person and/or the user for a predefined period of time. A pause in the conversation may be considered a stopping of the conversation based on the rhythm of the conversation and how often the parties to the conversation naturally take a break between speaking. In some implementations, the connection may continue during a temporary pause that last less than a predefined pause time. Silence lasting longer than the pause time may result in the disconnection of hearable devices.

The stopping action may also occur when the target person and/or user is found to have moved outside of a receiving distance available for connection by the hearable devices. The connection may be temporarily suspended where the parties are detected to have then moved back into the receiving distance within a suspension time period. In the case of a temporary suspension of the connection, the interaction period may recommence (e.g., without requiring repeated identification of the target person person) or a new interaction period may be initiated.

In some implementations, the stopping action may be detected by the communication system identifying predesignated stopping word(s), such as “goodbye”. “stop” or similar words/phrases by the user and/or target person. Other stopping actions may include user gestures detected by the system, such as tapping, facial expressions, hand motions, etc. At the stopping point, the conversation connection between the user hearable device 106 and target hearable device 116 may be disconnected.

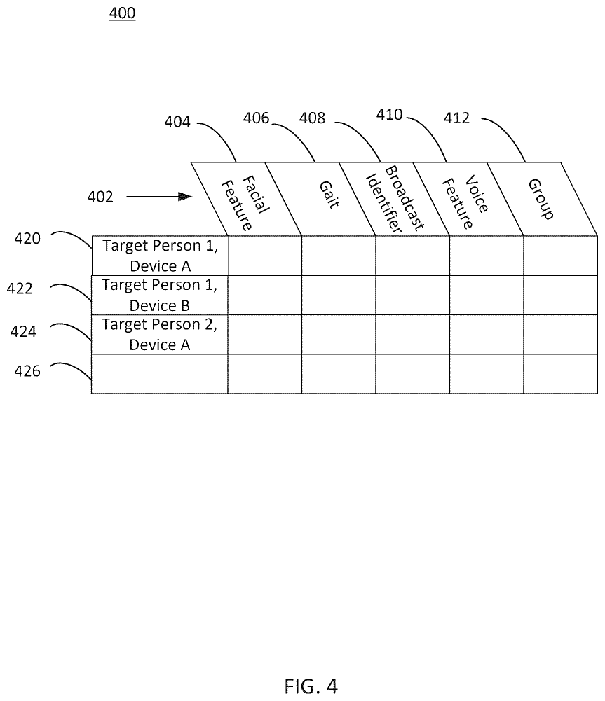

The background person 120 is also located in the environment 100 of the user. The background person 120 may be captured in the images but not identified by the system as a target person for a conversation with the user. For example, the background person 120 may be unidentifiable as not listed in a library (e.g., data table 400 in FIG. 4) of target persons of the user. Accordingly, background person 120 fails to trigger communication with the hearable device 106 of the user 102. However, should the user request to add the background person 120 to the library of target persons, the system may add identifying information for background person 120 to the library and initiate a conversation connection with a hearable device 122 (e.g. ear buds) of the background person, as described with respect to data table 400 in FIG. 4.

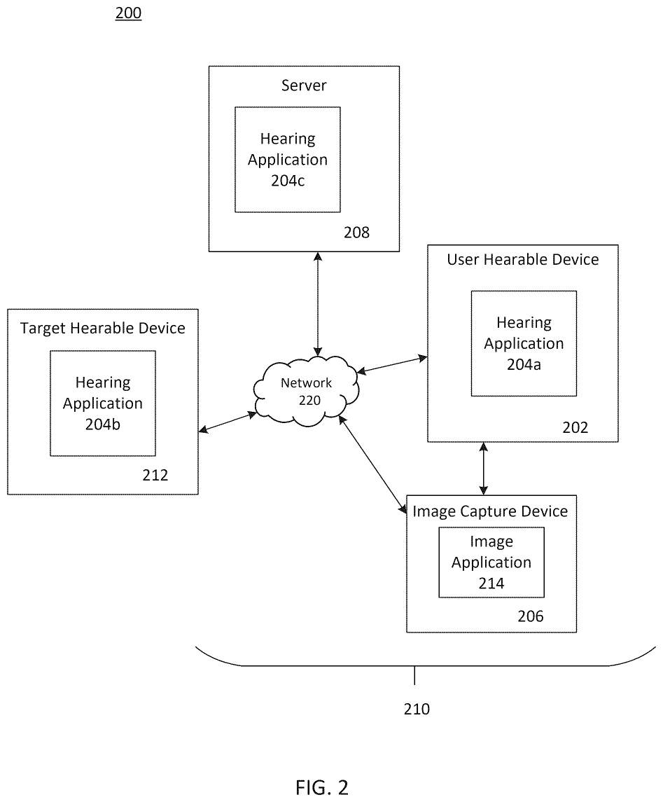

FIG. 2 shows a block diagram of an example of some basic components of an environment 200 that includes the hearable communication system 210. Components of the hearable communication system 210 may include user hearable device 202, image capture device 206 and/or server 208 (optional), which may be connected via network 220.

The hearable device 202 connects with the image capture device 206 via user hearing application 204a and determines at least one target hearable device 212 based, at least in part, on analysis of images from the image capture device 206. The image analysis may be performed by the user hearing application 204a, image application 214 of the image capture device, and/or server hearing application 204c of the server 208, or a combination of steps may be performed by both user hearing application 204a or server hearing application 204c. For example, the user hearing application 204a may extract visual indicators from visual content captured in the images, send the visual indicators to the server hearing application 204c to search one or more libraries stored at the server or third party storage entity to locate the visual indicators corresponding to a target person. Image recognition processes may also be offloaded to be performed by an external device, such as a smart phone or server, in communication with the hearable communication system, e.g., Bluetooth, WiFi, etc.

The hearing application 204a transmits, via network 220, a request for a connection to a target hearing application 204b of the target hearable device 212. A target hearable application 204b may receive the request and determine whether the connection is approved, e.g., a target person inputs an acceptance of the request for the connection. Responsive to the user hearing application 204a receiving an acknowledgement from the target hearable device 212, the user hearing application 204a subscribes to the connection. The user hearing application 204a communicates with the target hearable device until the interaction period ends.

The network 220 may include a local area network, a wide area network, a wireless network, an Intranet, the Internet, a private network, a public network, a switched network, cellular, wired connections, or any other communication network, such as for example Cloud networks, suitable for connecting the components. Typically, network 220 includes a short-range connection between the user hearable 202 device and target hearable device 212, such as Bluetooth Low Energy (BLE) connection. Other connections are possible such as wide band and ultra-wide band. A connectable advertising packet may be broadcast by the user hearable device, such as a BLE advertising packet, receivable by the target hearable device, may be disseminated. The advertising packet may provide notice to the target hearable device 212 that a communication connection may be established with the user hearable device 202 for purposes of a conversation between the user and target person.

Other configurations of the communication system 200 may be employed and are considered within the scope of this disclosure. Various designs and configurations of a hearable device may be used. For example, in some implementations, a server need not be employed, a mobile device of the user or target persons may be used for some of the processes, etc.

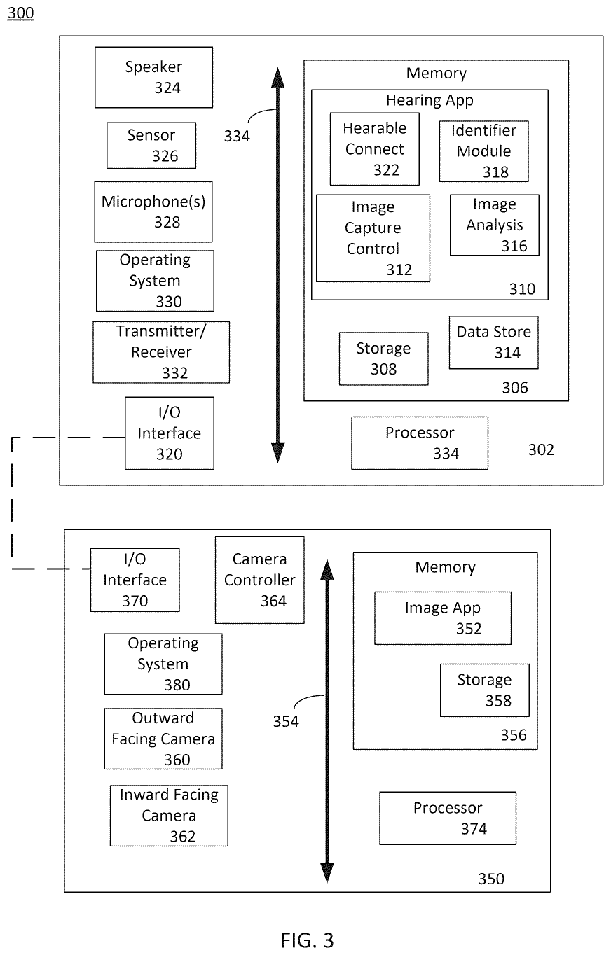

FIG. 3 shows components of the hearable communication system 300 by way of a block diagram, including user hearable device 302 and image capture device 350.

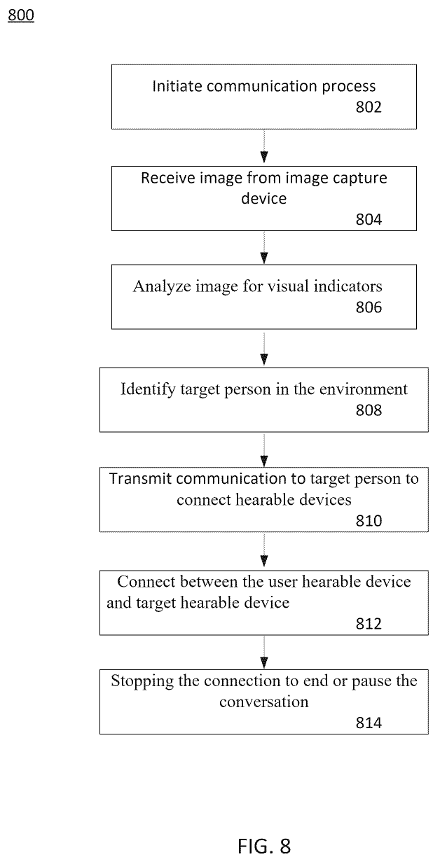

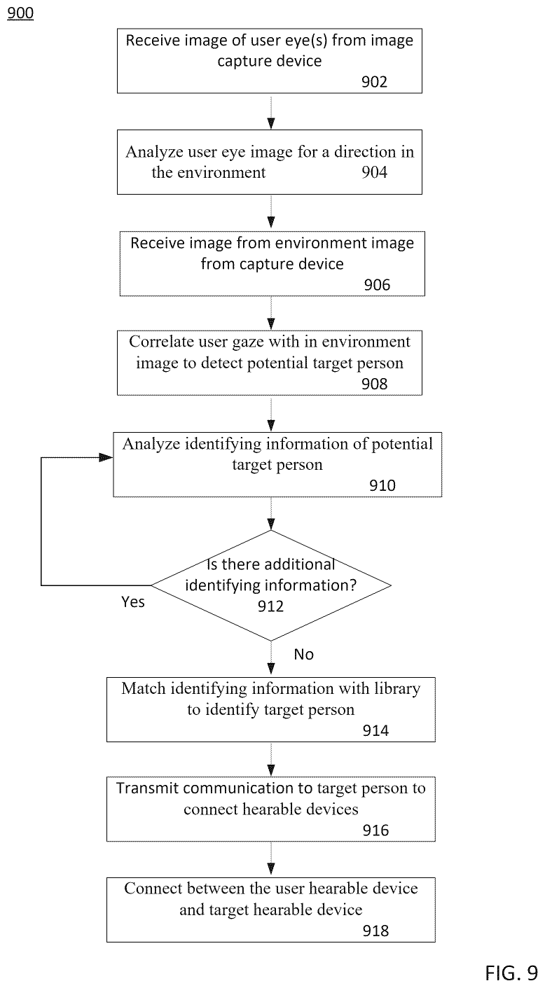

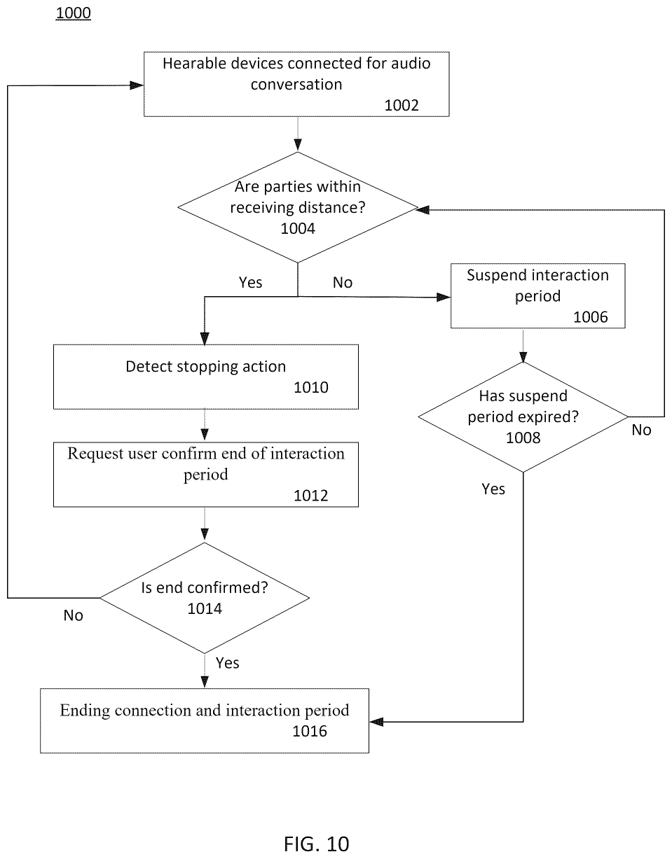

The user hearable device 302 includes hardware and/or software to perform operations to connect with a target hearable device, such as operations described below with regard to FIGS. 8-9 and disconnect the hearable devices, such as operations described below with regard to FIG. 10. For example, the user hearable device 302 includes one or more processor(s) 334 and logic encoded in one or more non-transitory media for execution by processor(s) 334 and when executed operable to perform the operations. At least some of the hardware and/or software may also be in other parts of the communication system 300, such as image capture device 350 and/or server (e.g., 208 in FIG. 2).

The user hearable application 310 includes various modules to perform functions of the communication process. Modules may include image capture control 312, image analysis 316, identifier module 318, and hearable connect module 322.

Image capture control module 312 directs the image capture device 350, via I/O interface 320, to commence capturing images of the environment of the user. The image capture control module 312 may further transmit controls for particular camera parameters to the image capture device 350, for example, to specify focus, resolution, and zoom levels on a particular part persons to capture a visual indicator, such as focus on the face, eyes, or ears of persons in the environment. In some implementations, the user hearable application 310 need not control the image capture device, for example, the user may manually control the capturing of images.

Image analysis module 316 performs assessment of the images received via I/O interface 320 of the user hearable device 302 and sent from the I/O interface 370 of the image capture device 350. The image analysis module 316 may extract visual indicators from images captured during a particular time period, e.g., in which the user hearable device is in a communication mode. The visual indicators include distinguishing visual characteristics of various persons in the environment of the user, e.g., in the field of view of an outward facing camera(s) 360 of the image capture device 350 described below.

In some implementations, the image analysis module 316 may further analyze inward facing images of the user captured by an inward facing camera (sensors) 362. For example, eyes of the user may be assessed to determine a direction of gaze by the user to be fixed on a particular point in the environment and/or movement of the eyes toward a particular direction. The image analysis module 316 may correlate the eye gaze/movement of the inward facing image(s) with persons captured in images by the outward facing camera to determine persons in the environment that the user is looking at or toward. Such persons that the user pays visual attention to may be candidates to be identified as target persons to connect hearable devices.

The identifier module 316 may maintains lists of identifying information, such as visual indicators, broadcast identifiers, speech, groups, etc. In some embodiments, the identifier module 316 creates groups of identifiers from a personal library or a common library. The identifier module 304 may create the personal library from the user's contacts (responsive to the user providing permission to access their contacts), from instructions provided by the user (e.g., the user asks to save particular auditory devices to one or more groups), etc.

The identifier module 304 may create the common library from predefined groups. The common library may include a social group or club, company group (e.g., employees of a company that the user is associated with, people that are attending the same work conference, etc.), a business group (e.g., so the user can speak with employees of a business), and/or a public institution group (e.g., the user might want to speak with a librarian at a busy library), etc.

In some implementations, some or all of the identifying steps may be off loaded to a server. For example, the libraries may be stored remotely at a server and the server may match visual indicators and/or other identifying information of the target person or target hearable device with corresponding identification of the target person. The identification may be in the form of a name, nickname, group name, member identification number or other unique identifier personal to the target person and/or target hearable device.

The hearable connect module 322 may transmit a communication to connect via the I/O interface 339 to the target hearable device, such as a request to connect or a response to a pairing request from the target hearable device. The connection may be a Bluetooth connection, a Wi-Fi connection, a proprietary connection produced by the manufacturer of the user hearable device, or another type of wireless connection. If the connection is compatible for multiple simultaneous connections, such as Bluetooth LE Audio or Wi-Fi, the user hearable device may maintain multiple connections for a conversation with more than one target persons.

In some implementations, the hearable connect module 322 may also determine if an acknowledgement is received from the target hearable device. If the acknowledgement is not received (e.g., if the acknowledgement is not received within a predetermined amount of time), the hearable connect module 322 may halt the connection and go back to scanning for target persons in captured images. If the hearable connect module 322 receives the acknowledgement, the hearable connect module 322 may subscribe to the connection. In some implementations, the hearable connect module 322 can maintain an encrypted connection. The encrypted connection may turn off when more than two hearable devices are part of the connection.

In still other implementations, the connection may be made in response to a pairing request from the target hearable device based on identification of the target person, without the need of receiving a return acknowledgment from the target hearable device.

In some implementations, the hearable connect module 322 may also scan for hearable devices that are within a communication range of the user hearable device. For example, if the communication protocol is Bluetooth, the communication range may be less than 30 feet. If the communication protocol is Wi-Fi, the communication range may be less than 160 feet.

In some implementations, in response to identifying the target person, the identification may be output to the user, such as via speaker 324, display on another user device or other output mechanism, with a request for the user to confirm an intent to connect with the target person.

Confirmation from the user may be determined by various input mechanisms, such as microphone 328 detecting user instructions from the user to connect with the target hearable device, or by a sensor 326 of the user hearable device 302. Sensors may include a voice pick-up sensor that identifies jaw vibrations, a motion sensor (or more specifically, a proximity sensor) that detects gestures or a tap from the user that indicates that the user wants to connect with the particular auditory device. The gesture may be directed toward the target person. For example, the hearable connect module 322 may determine that the gesture refers to a person directly in front of the user instead of a person off to the side.

In some implementations, the I/O interface 320 may also receive input from the user, such as user commands to operate aspects of the communication system, e.g., turn on/off the communication system, adjust speaker volume, etc. In some implementations, one hearing unit may communicate through I/O interface 320 to coordinate with another hearing unit in the pair of units of the hearable device. The I/O interface 320 may also be enabled for wireless communication, such as via Wi-Fi, Bluetooth, Bluetooth Low Energy (BLE), radio frequency identification (RFID), etc. Wireless communication by the hearable device may connect with other computing devices, such as a smart device of the user, e.g., smartphone, smart watch, etc. In some implementations, hearable device 300 may also include software that enables communications of I/O interface 320 over a network such as HTTP, TCP/IP, RTP/RTSP, protocols, wireless application protocol (WAP), IEEE 802.11 protocols, and the like. In addition to and/or alternatively, other communications software and transfer protocols may also be used, for example IPX, UDP or the like.

Other common hearable device components may be included, such as an integrated circuit (IC) and a computer chip-embedded amplifier to receive sound input and convert electrical signals from the microphones to digital signals. The IC may include a digital-to-analog converter (DAC) or analog to digital converter (ADC). A power source often includes disposable and/or rechargeable batteries.

Other common system components may be included, such as integrated circuit (IC) and computer chip-embedded amplifier to receive sound input and convert electrical signals from the microphones to digital signals. The IC may include a digital-to-analog converter (DAC) or analog to digital converter (ADC). Power source often includes disposable and/or rechargeable batteries.

The user hearable device 302 typically includes other familiar computer components such as a processor 334, and memory storage devices, such as a memory 306. A bus 334 may interconnect hearable device components.

Memory 306 may include solid state memory in the form of NAND flash memory and storage media 308. The computer device may include a microSD card for storage and/or may also interface with cloud storage server(s). Memory 306 and storage media 308 are examples of tangible non-transitory computer readable media for storage of data, audio files, computer programs, and the like. Other types of tangible media include disk drives, solid-state drives, floppy disks, optical storage media and bar codes, semiconductor memories such as flash drives, flash memories, random-access or read-only types of memories, battery-backed volatile memories, networked storage devices, cloud storage, and the like. A data store 314 may be employed to store various on-board data, such as stored identifying information of target persons, etc.

A transmitter and receiver 332 may process sound signals. The transmitter decodes speech of the user captured via the microphone into a transferable format (e.g., audio frequency) and then sends the information, such as through radio waves to the target hearable device. The receiver picks up on speech signals from the target hearable device and decodes the speech signals into a format for hearing by the user.

User hearable device 302 further includes an operating system 330 to control and manage the hardware and software of the computer device 302. Any operating system 330, e.g., mobile OS, that supports the hearable communication methods may be employed, e.g., IOS, Android, Windows, MacOS, Chrome, Linux, etc.

In some implementations, the image capture device 350 is a smart device, such as a wearable camera device, that includes computing components, some of which are similar to the components described above for the user hearable device 302 and adapted for the image capture device 350, such as a memory 356 (similar to memory 306), a processor 374 (similar to processor 334), operating system 380 (similar to operating system 330), storage 358 (similar to storage 308), I/O interface 370 (similar to I/O interface 320), and bus 354 (similar to bus 334). In some implementations, the image capture device may also include a display screen and function to display different types of visual content to the user.

Image application 352 may process the images for receipt by the user hearable device 302. Depending on the recognition algorithms being employed, the images may be enhanced using techniques to improve recognition, such as face hallucination algorithms. Camera controller 364 directs capture of images by the outward facing camera and/or inward facing camera. The camera controller 364 may further focus parameters of the image capture device 350 on particular persons in the environment, such as according to directions received by the user hearable device 302. For example, for gait analysis, images may be taken of a person farther in the distance from the user to extract gait biometric indicators from a sequence of images.

Outward facing camera 360 captures the images, e.g., video frames and/or still photographs, within a field of view in the environment. More than one outward facing sensor may be included. The outward facing camera 360 may include various types of sensors depending on the image recognition technique used, such as traditional cameras (with different lenses such as wide angle lens), thermal sensors, depth sensors, near-infra red sensors, light detection and ranging sensors (LiDAR), time-of-flight cameras, etc. In some implementations, specialized lenses may be employed for particular recognition techniques, such as identifying eye characteristics (e.g., iris recognition) over a certain distance, such as 6 to 7 feet away from the user. In some implementations, the image capture device 350 may also include an inward facing camera 362 to capture images of the face of the user, such as the eyes of the user.

The components of the communication system 300 are merely illustrative and not intended to limit the scope of the claims. One of ordinary skill in the art would recognize other variations, modifications, and alternatives.

FIG. 4 illustrates a data table 400 of a library to store various types of identifying information 402 to enable identifying a person as a target person for a conversation with the user. In the example of the data table 400 identifying information fields (arranged in columns) are provided for various target persons (arranged in rows).

In some implementations, at least some of the identifying information 402 in data table 400 may be particular to a hearable device of a target person. The example data table 400 shows target person 1, device A 420, target person 1, device B 422, target person 2 device A 424. In some cases, the data table 400 may be dedicated to a list of known target persons for the user. In other cases, the data table 400 may list potential target persons and once a potential target person is identified with the identifying information 402, the identified person is matched with a list of target persons for the user.

In some implementations, a new target person and/or a new hearable device for a known target person may be added in blank row 426. In some implementations, the data table 400 may be dedicated to the user and list only persons who are specified as target persons for the user. The user may request a new target person be added to the data table 400 or identifying information for an existing target person be deleted from the data table 400. For example, the connection system may identify a person in the environment who is not in the data table and may present the user with a description (e.g., name) of the potential new target person for the user to accept or decline. Upon receiving user instruction to add the new target person, the identifying information 402 of the new target person may be added to blank row 426.

Biometric visual indicators are extracted from images captured by the image capture device and compared with stored biometric data within an identification library of persons, such as the data table 400 example in FIG. 4. Each data table 400 may be specific to target persons for a particular user. In such cases, identification of a person by the data table 400 is determinate of a target person. In still some implementations, the data table 400 may general to include both non-target persons and target persons of a user. In such implementations, additional matching steps may be employed to identify a target person, such as matching an identified person listed in general data table 400 to a separate list of target persons for the user.

Various types of libraries may be used to store identification data. Often, a personal library may be employed to store data of persons strongly associated with the user, such as persons previously identified as significant to the user. In some implementations, a common library may include persons indirectly associated with the user, such as members of a group that is affiliated with the user. The user may have not had previous contact with persons whose identification data is stored in the indirect relationship database. In still some implementations, a general library may store data for various persons, some of whom may be associated with the user and others who are not yet associated with the user, as described above.

Identifying information 402 in data table 400 includes visual indicators detected in the images, such as facial features 404. Such visual indicators may be used in various visual identifying techniques using physiological features, including facial recognition, iris recognition, ear recognition, etc. to identify a human face in the environment of the user. Other visual indicators unique to a person may also be extracted from the images and employed for identification of the target person.

Other visual indicators may include gait features 406, such as walking style and pace data and/or locations of ankle, knee, and hip during movement. Gait feature data 406 may be interpreted from a sequence of images of a target person walking in the environment. For gait recognition techniques, the target person may be at a farther distance from the user than distances required for recognition techniques using certain other visual indicators (e.g., facial features) and the target person may not need to be facing the user.

In some implementations, in addition to visual indicators, broadcast identifier 408 may be stored in data table 400. Broadcast identifiers include various unique identifiers, such as a Media Access Control (MAC) addresses, for a particular device that is associated with a target person or potential target person. The broadcast identifier may be transmitted in the form of radio waves (e.g., Bluetooth) from a beacon coupled to or integrated with the target hearable device of a target person, and received by the user hearable device or received by other receivers associated with the user hearable device. The user hearable device may scan for the broadcast identifier 408 on an ongoing basis or intermittently, for example when the user hearable device is in a communication mode.

In still some implementations, a target person may be listed as associated with a particular hearable device by the broadcast identifier 408. In situations in which the target person uses a new hearable device that has not previously been stored in data table 400, for example the target person switches hearable devices, the stored broadcast identifier may be insufficient to identify the target person alone, as a different broadcast identifier 408 is stored than the received new broadcast identifier that is currently used by a hearable device of the target person. In such cases, identification of the target person may rely on other identifying information such as visual identifiers, e.g., facial features 404. Once identified as a target person to talk with, the new broadcast identifier may be store for the new device.

In some circumstances, the broadcast identifier 408 for a particular hearable device may change. For example, use of security protocols, such as randomizing MAC addresses, may result in a changed broadcast identifier for a same hearable device. In the case of a changed broadcast identifier 408 for a listed hearable device of the target person, who is identified through user of other identifying information, the broadcast identifier data may be updated in the data table 400 by replacing (e.g., overwriting) an outdated broadcast identifier with a new broadcast identifier for a hearable device, or simply adding the new broadcast identifier to the list associated with the target person.

In some implementations, in addition to the visual indicators in the images used for identification, the target person may be identified by analyzing the speech of the target person to detect audio characteristics of the speech (also referred to as voice features, voice print or voice profile) that contribute to identification of the target person. In some implementations, with appropriate permissions, the hearable communication system may employ microphone(s) of the user hearable device to detect and record a sample of the speech of a potential target person while in the environment of the user. The audio characteristics of the snippet of speech may be matched with voice features 410 in the data table 400 for target person identification. In some implementations a voice recognition artificial intelligence model may be employed to classify a detected voice and predict a target person.

In some implementations, stored identifying information may include group information 410 in which a target person participates, is a member, or is otherwise associate. Examples of groups may include a work group, club, friend group, a family group, a neighbor group, and/or a home internet of things (IoT) group.

In some implementations, a group target person may be identified primarily or solely based on the person belonging to a group of another target person who is identified, such as by other visual indicators and/or other identifying information. For example, where a target person is captured in an image and identified by facial features and is known to be a member of a group, another target person in the environment may be found to be a group target person, even if visual content in the images do not pick up on the group target person sufficiently for identification purposes. The user may be asked to confirm whether to add the group target person to the conversation. Where confirmation is received, a request to connect with the user may be transmitted to the group target person. In some implementations, the user may also be a member of the group. Upon receiving acknowledgment from a hearable device of the group target person, a communication connection may be established between the user hearable device and the group target hearable device.

In some implementations, target person identification may be multi-modal and rely on more than one type of visual indicator. Various combinations of visual indicators and other identifying information may be employed. For example, facial recognition and broadcast identifiers for known devices of the target person may be used to identify a target person. In still some implementations, eye tracking images may be used to supplement receipt of a broadcast identifier (with or without use of facial recognition of environment images) to identify a target person.

In some implementation, various types of identifying information may be associated with different weights used to estimate a reliability value. The communication system may calculate the reliability value based on matching of various identifying information in determining whether a particular person is a target person. Where the reliability value meets a confidence threshold, the matching of identifying information is determined to be sufficiently satisfied for the detected person to be identified as a target person. In some implementations, individual confidence thresholds may need to be satisfied for individual reliability values of each type of identifying information (e.g., facial features, voice, gait) being employed. An overall confidence threshold may also need to be satisfied for a total reliability value of the combination of identifying information matching to satisfy, with or without employing weights for the individual types of identifying information.

In some implementations the identifying information represented in data table 400 may be used as training datasets to train an identification artificial intelligence (AI) model to predict whether a person detected in the user environment is a target person for a communication connection with the user. The trained identification AI model conducts predictive analysis using the identifying information as input and outputs the prediction as to whether a potential target person in the environment, captured in images of the image capture device, can be identified (classified) as a target person. In some implementations, the identification AI model may also employ supplemental information such as a description of the environment (building, room), date and/or time of day, activity of the user (e.g., currently working, social gathering, event) to predict a target person.

Although the description of the data table 400 has been described in FIG. 4, this example is merely illustrative, and not restrictive. Variations of the data table 400 are possible with more or less of the identifying information 402 described. In some implementations, individual data tables may be employed for each type of identifying information or combinations of identifying information. In some implementations, various data tables may be stored at the user hearable device, a computing device of the user that is in communication with the user hearable device, or a remote server.

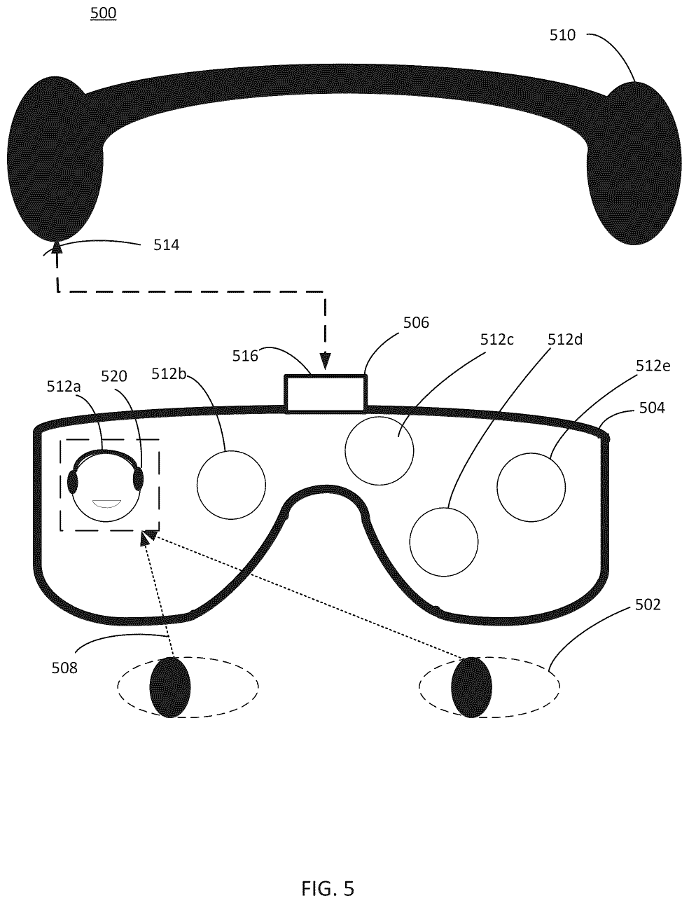

FIG. 5 shows an example of the hearable communication system 500 in which eye tracking functionality may be implemented to facilitate identification of a target person. Such user eye tracking may focus identification processes on the person(s) that has/have the user's attention, rather than identifying all persons captured in the environment. Identification of the target person may also be performed by combining eye tracking techniques with other techniques to analyze visual and non-visual indicators.

An image capture device 504 includes one or more image capture sensors 506 such as an inward facing sensor positioned to detect user eye movement and/or gaze in a direction 508 (illustrated by dotted arrow line) that indicates a target person located in the field of view. Various known eye tracking techniques may be employed. The inward facing sensor may also detect other visual aspects of the user, such as facial expression, which may be used in identifying a target person with whom a user intends to converse.

In this example, an image capture device is provided as a wearable device in the form of smart goggles or glasses that functions in conjunction with the user hearable device 510. The image capture device may be in other forms as well, such as a headset, and other devices that include the image capture sensor positioned to capture eye movement of the user.

The image capture sensors 506 may include one or more outward facing sensors to detect objects in the field of view of the user. Images (including image data) may be transferred via I/O interface 516 to the user hearable device 510 I/O interface 518. The connection may be two-ways in which the user hearable device 510 directs the functioning of the image capture device 504.

Images of the outward facing sensors may capture various persons 512a, 512b, 512c, 512d, and 512e in the environment. The hearable communication system 500 matches the direction 508 of the eye movement and eye gaze with person 512a and determines that person 512a wearing hearable device 520 is a potential target person (illustrated by imaginary dashed rectangle around person 512a). The hearable communication system 500 performs an identification process using identification information of potential target person 512a to identify target person 512a. The communication system 500 need not perform the identification process on the other persons 512b, 512c, 512d, and 512e captured in the images but to which the user pays no attention. In this manner, less resources of the communication system are required and less time is needed to identify target persons, than processing all persons in an environment.

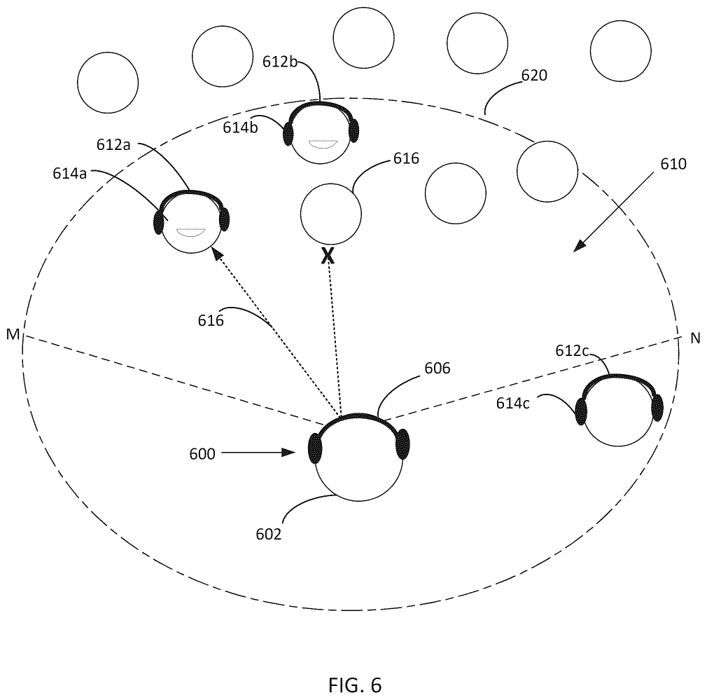

FIG. 6 shows an example of the hearable communication system 600 that uses group identification information to facilitate identification of target persons for conversation with a user 602. The hearable communication system 600 includes a user hearable device 606 and an image capture device (not shown) of the user 602.

The image capture device captures images from an area 610 within a field of view (defined by large dotted lines M-N) in the environment of the user and communicates the image data to the user hearable device 606. Potential target person 612a wearing hearable device 614a is captured in at least one of the images. Potential target person 612a is identified as a target person 612a by image analysis to extract visual indicators and possibly other identifying information that matches with stored identifying information in a library of target persons. The stored identifying information for target person 612a also includes a group to which target person 612a is a member. In some implementations, user 602 may also be a member of the group or otherwise associated with or affiliated (directly or indirectly) with the group.

Based, at least in part, on the group identifying information, other persons also listed as being members or affiliated with the group may be designated as potential group target persons 612b and 612c. In some implementations, the user may be presented with the list of such potential group target persons and confirmation of the communication connection may be inputted by the user into the communication system. Upon receiving user confirmation, a request for connection may be transmitted to the potential group target persons. In still some implementations, the request for connection may be sent automatically with the need for user confirmation. Potential group target persons who are within a receiving distance 620 of the user hearable device, e.g. in the environment, may receive the requires and acknowledge the connection of target hearable device 614b for group target person 612b and target hearable device 614c for group target person 614c, to participate in the group conversation.

In some implementations, identification of group target persons may not require capture of such persons in images of the image capture device. Thus, group target person 612b may participate in the communication connection even though group target person 612b is at least partially blocked by other objects, for example blocking person 616, such that visual content in the images is insufficient to identify the group target person 612b in the environment of the user. Furthermore, group target person 612c may be located outside of the field of view area 610 and not captured in the images. Yet, where group target person 612c is within the receiving distance 620 of the user hearable device 606. The group target person 612c may participate in the communication connection without sufficient visual indicators in the images for identification.

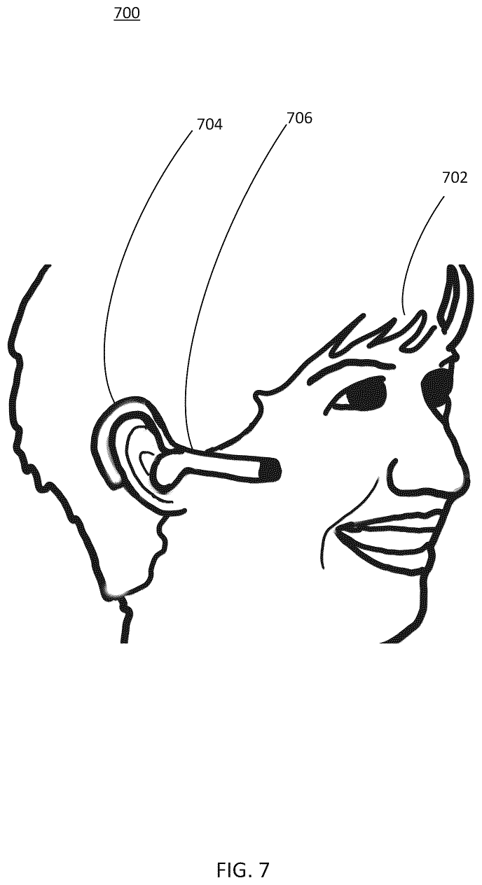

FIG. 7 shows and example of a hearable communication system 700 having an image capture device 706 attached to a user hearable device 704 worn by a user 702. In some examples, the image capture device may be integrated with the user hearable device 704 in the form of a hearing aid.

FIG. 8 shows a flow chart of a hearable communication process 800 in which a hearable device connects to another hearable device for an audio conversation. The communication process 800 is performed by hearable communication system, for example system 300 shown in FIG. 3 and in particular, user hearable device 302 in FIG. 3.

In block 802, the communication system initiates the communication process 800 in response to a trigger. In some implementations, a communication mode of the communication system is activated and the system scans for potential target persons in the environment. The communication mode may be activated by the user providing input to the hearable communication system. Other triggers for communication mode may include a specific time of day, location of the user, or other prompts to start or stop the communication process. In some implementations, the communication process may commence and the user may override the process, for example by the user declining to connect and converse with a target person. In some other implementations, a communication mode may be activated by a user hearable device, scanning for broadcast identifiers, detecting a broadcast identifier stored in a library of target persons or potential target persons.

In block 804, one or more images are received from the image capture device, such as 350 in FIG. 3. In block 806, the received images are analyzed to detect one or more visual indicators that may assist in identifying person(s) in the environment. The visual indicators that may be extracted from images depend on the biometric identification technique employed, such as facial feature data (e.g., measurements between features, position, size and/or shape related to eye, nose, mouth, cheekbone, jaws, bone structure, etc.), iris color patterns, gait patterns (e.g., measurements body parts when walking). Analysis of images may include visual identifying techniques such as facial recognition, iris recognition, gait recognition, other mathematical pattern-recognition techniques and/or combinations thereof. Analysis may consider various weights for different types of visual indicators as well as other identifying information. In some implementations, analysis may be performed by an identification AI model.

In block 808, at least one target person is identified as present in the environment. Identification may result from a match of captured visual indicators with stored distinguishing visual characteristics of a target person. The match may need to satisfy a confidence threshold value for the identification to be successful.

In block 810, a communication is transmitted to target person to connect the target hearable device with user hearable device. The communication may be in the form of a request for acknowledgement of the communication connection. In some implementations, the communication may be a confirmation from the user to accept a request from the target person to pair hearable devices.

In some implementations, a request to confirm a communication connection with the target person may be outputted to the user, such as through a display on a mobile device (e.g. smart phone) of the user or audio output through speakers of the user hearable device. In response, at least in part, to receiving a confirmation from the user, the communication connection may be established in block 812. In some implementations, the communication system also needs the target person to send the acknowledgement and in response to receiving the acknowledgement, the communication connection may be established in block 812.

The communication connection may be stopped in block 814 to end or pause the conversation. For example, microphones of the user hearable device may detect that the audio conversation has stopped for a predefined period of time and in response, the communication connection may be disconnected. Other stopping triggers may include receiving user input requesting the stop, detection of trigger words by the user and/or target person, the target person being outside of the connection distance with the user, etc.

FIG. 9 is a flow chart of a multi-modal communication process that uses various identifying information to identify a target person. The multi-modal process 900 is performed by communication system for example, as shown in FIG. 300 in FIG. 3.

In some implementations, the communication system may monitor eye gaze. In block 902, images of user eye(s) are received from an inward facing camera of the image capture device.

In block 904, the captured and received user eye image(s) are analyzed to pinpoint a direction of user eye gaze. Several known eye gaze analysis algorithms may be employed. In some implementations, a fixed time factor may be used that considers or requires a length of time that the user fixes at a point in the environment, such as 5-10 seconds, determined by analysis of multiple sequential eye images.

In block 906, environment image(s) from an outward facing camera capturing the user environment is/are received, similar to the receiving step described above in block 804 with regards to FIG. 8.

In block 908, the determined eye direction from block 904 is correlated with the environment image(s) received in block 906 to detect one or more potential target person(s). The direction of the eye gaze may be aligned with a location of potential target persons in the environment, extrapolated from the environment images, to estimate which person(s) the user looks toward.

In block 910, identifying information related to the potential target person are extracted from the environment images and analyzed, similar to the analysis step described above in block 806 with regards to FIG. 8.

In decision block 912, it is determined whether there is additional identifying information associated with the potential target persons. If there is additional identifying information to analyze, the process returns to block 910 to analyze the next identifying information.

Where there are no additional identifying information to analyze, the process continues to block 914. In block 914, identifying information is matched with library to identify target person.

In block 916, a communication is transmitted to the target person to connect hearable devices similar to the communication transmission step described above in block 810 with regards to FIG. 8.

In block 918, a connect is established between the user hearable device and target hearable device, similar to the connection step described above in block 812 with regards to FIG. 8.

FIG. 10 shows a flowchart of an example stopping process to disconnect a connection of hearable devices for an audio conversation.

In block 1002, hearable devices are connected for an audio conversation among persons wearing the hearable devices. Connection of the hearable devices may be made, for example, using the connection processes described in FIGS. 8 and 9 above.

In decision block 1004, it is determined whether the parties to the (user and target persons) audio conversation are located with in a receiving distance for the hearable devices to connect. The receiving distance includes the closeness between devices needed for a connection that allows for the audio conversation signals to be sent and received. The receiving distance depends, at least in part, on the type of wireless connection, Bluetooth, Bluetooth LE Audio, wide band, ultra-wide band, etc., that is made between hearable devices. Other factors may be the environment, presence of signal interferences, etc.

When the receiving distance is not met, the connection and interaction period may be suspended in block 1006 at least for a suspension period of time while it is determined whether the suspension period has expired in decision block 1008. The interruption may be temporary where the suspension period has not expired the disconnection process returns to block 1004 to monitor whether the parties have returned back within the receiving distance from each other. Should the parties move back into the receiving distance, the connection may continue without the need to identify the target person again. Where the suspension period has expired, the connection between hearable devices is ended (disconnected) and the interaction period has ended).

As the parties remain within the receiving distance for a reliable device connection, the disconnection process in block 1010 monitors for a stopping action that may indicate an ending of the conversation. Such stopping action may include particular words, phrases, or verbal cues spoken by the user or target person (such as “goodbye”, “end conversation”, “disconnect”, etc.) as detected by the microphones or jaw vibration sensor, gestures of the user (such as particular touching of the hearable device, facial expressions) as detected by the inward facing sensor, moving outside of the receiving distance (as discussed above), particular input (e.g., activating a button) on a computing device, and other actions that are predefined to indicate an intent of the user and/or target person to end the audio conversation. For example, the outward facing sensor of the image capture device may capture an image of the target person performing a stopping action such as waving goodbye to the user. Such stopping action may be detected by analysis of the images. In other implementations, the inward facing sensor of the image capture device may capture stopping actions made by the user, such as mouthing stopping words (e.g., goodbye) or other facial expressions predefined as stopping actions. Analysis of the images of the inward facing sensor may detect such stopping actions. Stopping actions may be detected in the images by image recognition analysis.

In block 1012, the user may be requested to confirm that the interaction period is ending. User confirmation of the stopping point may be spoken by the user, gestures, interacting with a display screen (e.g., of a computing device), etc. In is checked as to whether the confirmation is received in decision block 1014 and if not received for a waiting period of time, the process may return to block 1002 to continue the connection for the audio conversation. In some implementations, the system may receive user input to override a disconnection and the connection is maintained as in block 1002.

In block 1016, where the stopping point is confirmed the connection ends, disconnecting the hearable devices, and the interaction period is ended between the parties.

The processes of FIGS. 8, 9, and 10 described herein can be performed via software, hardware, and combinations thereof. The process may be carried out in software, such as one or more steps of the process carried out by the hearable communication system. Although the description has been described with respect to particular implementations thereof, these particular implementations are merely illustrative, and not restrictive. For example, in some implementations, the communication system may initially scan for broadcast identifiers and a broadcast identifier may be recognized in a library as associated with a potential target person. In response to recognizing the broadcast identifier, the communication processes in FIGS. 8 and/or 9 may be performed.

Computer programs are employed and when executed by one or more processors, are operable to perform various tasks of methods including the communication processes, as described above. The computer programs may also be referred to as programs, software, software applications or code, may also contain instructions that, when executed, perform one or more methods, such as those described herein. The computer program may be tangibly embodied in an information carrier such as computer or machine readable medium, for example, the memory, storage device or memory on processor. A machine readable medium is any computer program product, apparatus or device used to provide machine instructions or data to a programmable processor.

Any suitable programming language can be used to implement the routines of particular embodiments including IOS, Objective C, Swift, Java, Cotlin, C, C++, C#, JavaScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a non-transitory medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, etc. Other components and mechanisms may be used. In general, the functions of particular embodiments can be achieved by any means as is known in the art. Distributed, networked systems, components, and/or circuits can be used. Cloud computing or cloud services can be employed. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method for hearable devices to connect for an audio conversation, the method performed, comprising:
receiving at least one image of an environment of a user, from an image capture device of the user;
identifying a first target person in the environment by, at least in part, analyzing the at least one image;
in response, at least in part, to identifying the first target person, transmitting a communication to the first target person to connect a first hearable device of the first target person with a user hearable device of the user; and
establishing a first communication connection between the user hearable device and the first hearable device of the first target person.

2. The computer-implemented method of claim 1, further comprising prior to establishing the first communication connection:
outputting a request to the user to confirm the first communication connection with the first target person; and
receiving confirmation of the first communication connection from the user,
wherein establishing the first communication connection is in response to receiving the confirmation.

3. The computer-implemented method of claim 1, wherein identifying the first target person by analyzing the at least one image includes:
extracting one or more visual indicators from the at least one image; and
matching the one or more visual indicators with stored distinguishing visual characteristics of the first target person in one or more visual identifying techniques including facial recognition, iris recognition, gait recognition, and/or combinations thereof.

4. The computer-implemented method of claim 1, wherein identifying the first target person by analyzing the at least one image includes:
applying an artificial intelligence model trained on stored visual indicator data of known target persons to predict whether a potential target person in the at least one image is the first target person.

5. The computer-implemented method of claim 1, wherein identifying the first target person further includes:
receiving a broadcast identifier associated with the first hearable device; and
matching the broadcast identifier with a stored broadcast identifier.

6. The computer-implemented method of claim 1, wherein identifying the first target person further includes:
receiving a broadcast identifier associated with the first hearable device;
determining that the identified first target person is associated with a different broadcast identifier in a broadcast identifier library; and
adding the received broadcast identifier to the broadcast identifier library associated with the first target person.

7. The computer-implemented method of claim 1, wherein identifying the first target person further includes:
receiving speech from the first target person; and
matching one or more distinguishing audio characteristics of the speech with stored voice features associated with the first target person.

8. The computer-implemented method of claim 1, wherein identifying the first target person further includes:
receiving at least one eye image of the user captured by one or more inward facing capture sensors of the image capture device;
tracking an eye gaze of the user from the at least one eye image; and
determining the eye gaze is in a direction of the first target person.

9. The computer-implemented method of claim 1, further comprising:
determining the first target person is a member of a group that includes a second target person;
transmitting a request to the second target person to connect a second hearable device of the second target person with the user hearable device of the user; and
establishing a second communication connection between the user hearable device and the second hearable device of the second target person.

10. The computer-implemented method of claim 9, wherein visual content in the at least one image is insufficient to identify the second target person in the environment of the user.

11. The computer-implemented method of claim 1, further comprising:
detecting a stopping action indicating a stopping point of the audio conversation with the first target person via the first communication connection;
requesting user confirmation of the stopping point; and
in response to receiving the confirmation of the stopping point, disconnecting the first communication connection with the first hearable device.

12. A hearable communication system, the system comprising:
an image capture device of a user to capture at least one image of an environment of the user, the image capture device comprising an interface to transmit the at least one image to a user hearable device of the user; and
the user hearable device comprising:
one or more processors; and
logic encoded in one or more non-transitory media for execution by the one or more processors and when executed operable to perform operations comprising:
receiving the at least one image;
identifying a first target person in an environment of the user by, at least in part, analyzing the at least one image;
in response, at least in part, to identifying the first target person, transmitting a request to the first target person to connect a first hearable device of the first target person with the user hearable device; and
establishing a first communication connection between the user hearable device and the first hearable device of the first target person.

13. The hearable communication system of claim 12, wherein the image capture device includes a wearable device having one or more outward facing image capture sensors to capture the at least one image of the first target person in the environment, wherein the operations further comprise:
extracting one or more visual indicators from the at least one image; and
matching the one or more visual indicators with stored distinguishing visual characteristics of the first target person in one or more visual identifying techniques including facial recognition, iris recognition, gait recognition, and/or combinations thereof.

14. The hearable communication system of claim 12, wherein the image capture device further includes one or more inward facing image capture sensors and wherein the identifying the first target person includes:
tracking eye gaze of the user with at least one user eye image captured by the one or more inward facing capture sensors; and
detecting, from the at least one user eye image, the eye gaze toward the first target person.

15. The hearable communication system of claim 12, wherein the user hearable device includes at least one microphone, and wherein the operations further comprise:
receiving speech from the first target person by the at least one microphone; and
matching one or more distinguishing audio characteristics of the speech with stored voice features associated with the first target person.

16. The hearable communication system of claim 12, wherein the operations further comprise:
receiving a broadcast identifier associated with the first hearable device;
determining that the identified first target person is associated with a different broadcast identifier in a broadcast identifier library; and
adding the received broadcast identifier to the broadcast identifier library associated with the first target person.

17. The hearable communication system of claim 12, wherein the operations further comprise:
determining the first target person is a member of a group that includes a second target person;
transmitting a request to the second target person to connect a second hearable device of the second target person with the user hearable device of the user; and
establishing a second communication connection between the user hearable device and the second hearable device of the second target person.

18. A non-transitory computer-readable storage medium carrying program instructions thereon for connecting hearable devices for an audio conversation, the instructions when executed by one or more processors cause the one or more processors to perform operations comprising:
receiving at least one image of an environment of a user, from an image capture device of the user;
identifying a first target person in an environment of the user by, at least in part, analyzing the at least one image;
in response, at least in part, to identifying the first target person, transmitting a request to the first target person to connect a first hearable device of the first target person with a user hearable device of the user; and
establishing a first communication connection between the user hearable device and the first hearable device of the first target person.

19. The non-transitory computer-readable storage medium of claim 18, wherein the operations further comprise:
extracting one or more visual indicators from the at least one image; and
matching the one or more visual indicators with stored distinguishing visual characteristics of the first target person in one or more visual identifying techniques including facial recognition, iris recognition, gait recognition, and/or combinations thereof.

20. The non-transitory computer-readable storage medium of claim 18, wherein the operations further comprise:
receiving a broadcast identifier associated with the first hearable device;
determining that the identified first target person is associated with a different broadcast identifier in a broadcast identifier library; and
adding the received broadcast identifier to the broadcast identifier library associated with the first target person.

21. The non-transitory computer-readable storage medium of claim 18, wherein the operations further comprise:
determining the first target person is a member of a group that includes a second target person;
transmitting a request to the second target person to connect a second hearable device of the second target person with the user hearable device of the user; and
establishing a second communication connection between the user hearable device and the second hearable device of the second target person.
